(19) United States
(12) Patent Application Publication
(10) Pub. No.: US 2011/0084915 A1
(43) Pub. Date: Apr. 14, 2011

(54) ADJUSTMENT SYSTEM AND METHOD FOR CAMERA LENS

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/637,700

(22) Filed: Dec. 14, 2009

(30) Foreign Application Priority Data
Oct. 14, 2009 (CN) 200910308266.1

(51) Int. Cl. G06F 3/041

(52) U.S. Cl. 345/173

(57) ABSTRACT

A system is disclosed to adjusting a shooting angle of a camera lens. The system generates an electric signal relative to a contacting track of a touching device on a touch screen or a touch on the touch screen. The electric signal is processed to obtain a displacement of the touching device on the touch screen or a coordinate of the touch on the touch screen. A control signal is generated according to the displacement of the touching device on the touch screen or the coordinate of the touch on the touch screen. The system adjusts the shooting angle of the camera lens according to the control signal. Therefore, the camera lens captures images in a required area. The images captured by the camera lens may be displayed on the touch screen.

### BACKGROUND

1. Technical Field

The present disclosure relates to an adjustment system and a method for a camera lens.

2. Description of Related Art

Image capturing devices, such as cameras, can be employed in a monitoring system to capture images. Sometimes parameters of the image capturing devices need to be adjusted. Parameters of conventional image capturing devices can not be adjusted in response to electronic input of media players. For example, people may tilt a camera manually to capture images from different angles.

### BRIEF DESCRIPTION OF THE DRAWINGS

FIG. 1 is a schematic block diagram of an embodiment of an adjustment system including an electronic device.

FIG. 2 is a schematic diagram of the electronic device of FIG. 1.

FIG. 3 is a flowchart of a first embodiment of an adjustment method.

FIG. 4 is a flowchart of a second embodiment of an adjustment method.

### DETAILED DESCRIPTION

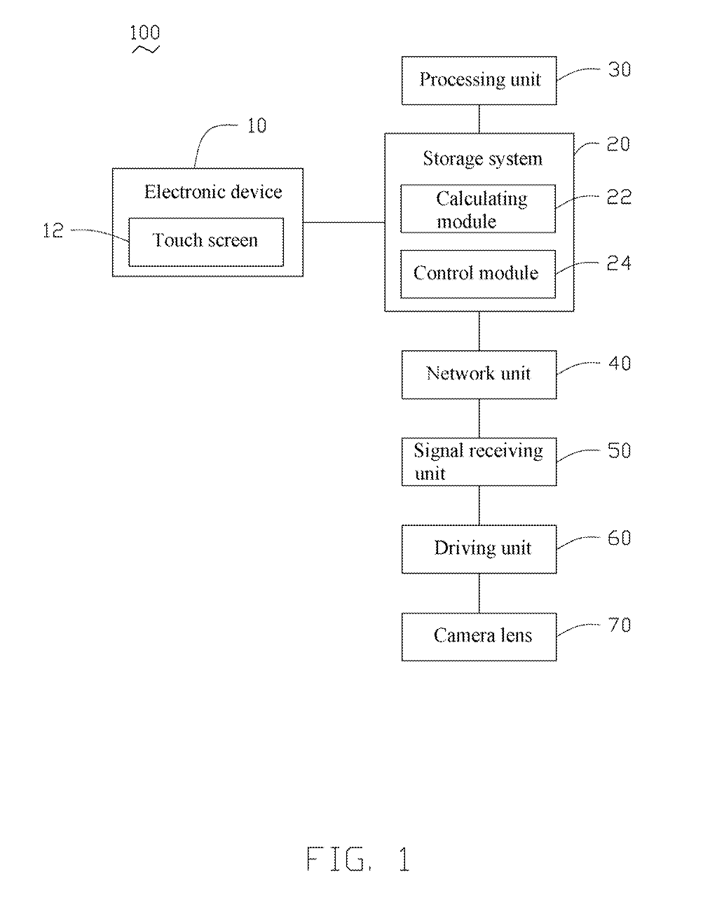

Referring to FIG. 1, an embodiment of an adjustment system 100 includes an electronic device 10, a storage system 20, a processing unit 30, a network unit 40, a signal receiving unit 50, a driving unit 60, and a camera lens 70. The electronic device 10 includes a touch screen 12. The adjustment system 100 is operable to adjust a shooting angle of the camera lens 70 by operating the touch screen 12. The touch screen 12 can also display images captured by the camera lens 70. In this embodiment, the electronic device 10 has a media player function, such as a mobile phone.

The storage system 20 includes a calculating module 22 and a control module 24. The calculating module 22 and the control module 24 may include one or more computerized instructions and are executed by the processing unit 30.

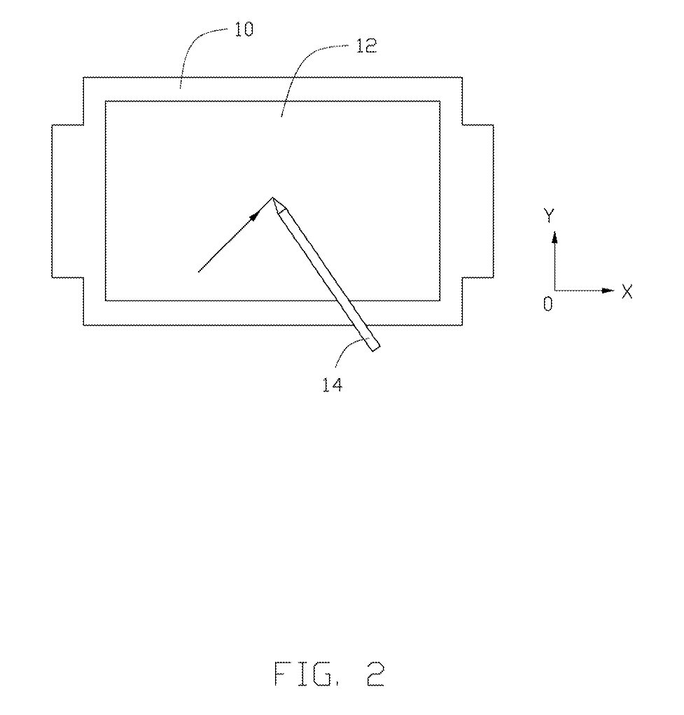

Referring to FIG. 2, the touch screen 12 of the electronic device 10 is a capacitive touch screen or a resistance touch screen. The touch screen 12 is operated by a touching device 14. The touching device 14 may be a stylus or a finger of a user which, when moved around while in contact with the touch screen 12, functions as an input device of the electronic device 10. The touch screen 12 is capable of converting tracks of the touching device 14 to electric signals.

The calculating module 22 receives the electric signals corresponding to tracks of contact of the touching device 14 from the touch screen 12, and calculates displacement of the touching device 14 on the touch screen 12 according to the electric signal. The displacement includes a distance and a direction that the touching device 14 moved. For example, a plane coordinate system may be defined on the touch screen 12, such as the XOY coordinate system as illustrated in FIG. 2. When the touching device 14 moves two units of distance along an upper right direction from a point of the touch screen 12, the calculating module 22 obtains a displacement of the touching device 14 which is described as (2 units, 45 degrees). Each unit of distance may be a length value, such as 1 centimeters (cm), corresponding to a distance that the camera lens 70 moves, such as 1.5 cm. When the touching device 14 moves one unit of distance along a lower right direction from a point of the touch screen 12, the displacement of the touching device 14 is described as (1 unit, −45 degrees).

The control module 24 receives the displacement of the touching device 14 from the calculating module 22, and outputs a control signal according to the received displacement. The network unit 40 transmits the control signal from the control module 24 to the signal receiving unit 50. The signal receiving unit 50 transmits the control signal to the driving unit 60. The signal receiving unit 50 may be an interface of the driving unit 60 or an antenna of the electronic device 10.

The driving unit 60 may be a pan motor. The driving unit 60 adjusts the shooting angle of the camera lens 70 according to the control signal. For example, if the signal receiving unit 50 receives the control signal, the driving unit 60 moves the camera lens 70 a required distance along a direction corresponding to the displacement of the touching device 14. For example, the driving unit 60 drives the camera lens 70 to move 3 cm to the left if the displacement of the touching device 14 is 2 units at 180 degrees. Therefore, the camera lens 70 can be controlled to shoot images in a desired area without manually adjusting direction of the lens 70. In this embodiment, the images shot by the camera 15 are transmitted to the touch screen 12 by the network unit 40, and are displayed on the touch screen 12.

In other embodiments, the electric signal may be relative to a touch of the touching device 14 on the touch screen 12. Each point of the touch screen 12 may correspond to a position of the camera lens 70. The calculating module 22 calculates a coordinate of a touch point on the touch screen 12 according to the electric signal relative to the touch of the touching device 14 on the touch screen 12. The driving unit 60 then moves the camera lens 70 to a position corresponding to the coordinate of the touch point.

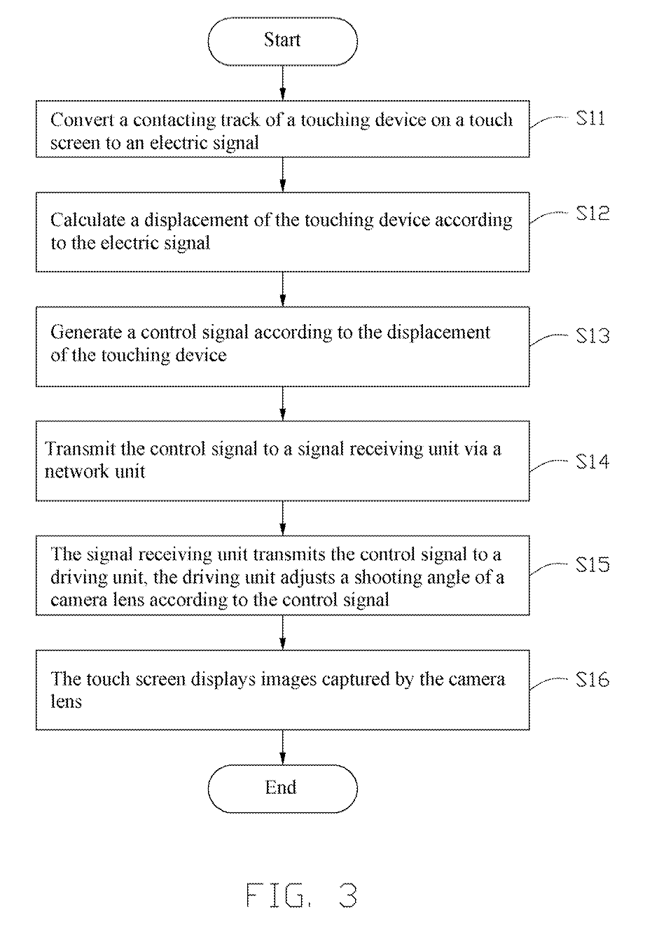

Referring to FIG. 3, a first embodiment of an adjustment method includes the following steps.

In step S11, the touch screen 12 converts a contact track of the touching device 14 on the touch screen 12 to an electric signal.

In step S12, the calculating module 22 receives the electric signal, and calculates a displacement of the touching device 14 according to the electric signal. The displacement includes a distance and a direction that the touching device 14 moved.

In step S13, the control module 24 receives the displacement of the touching device 14, and generates a control signal correspondingly.

In step S14, the control signal is transmitted to the signal receiving unit 50 via the network unit 40.

In step S15, the signal receiving unit 50 transmits the control signal to the driving unit 60. The driving unit 60 adjusts the shooting angle of the camera lens 70 according to the control signal. In this embodiment, the shooting angle of the camera lens 70 is adjusted by moving the camera lens 70 a required distance along a direction corresponding to the displacement of the touching device 14 without the need of direct manual adjustment.

In step S16, the images captured by the camera lens 70 are transmitted to the touch screen 12 via the network unit 40. The touch screen 12 displays the images.

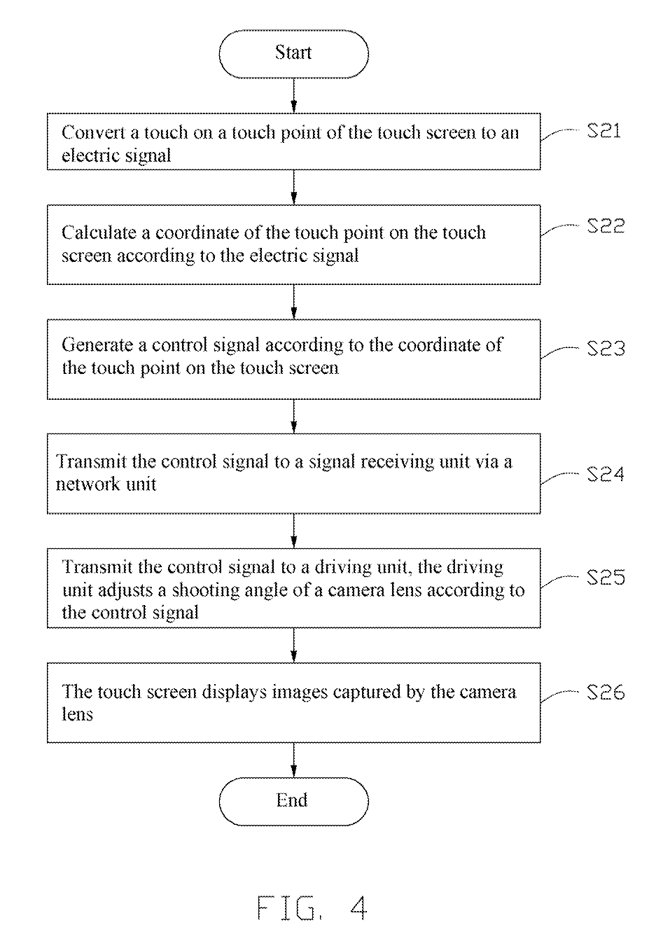

Referring to FIG. 4, a second embodiment of an adjustment method includes the following steps.

In step S21, the touch screen 12 converts a touch of the touching device 14 on a touch point of the touch screen 12 to an electric signal.

In step S22, the calculating module 22 receives the electric signal, and calculates a coordinate of the touch point on the touch screen 12 according to the electric signal.

In step S23, the control module 24 receives the coordinate of the touch point, and generates a control signal correspondingly.

In step S24, the control signal is transmitted to the signal receiving unit 50 via the network unit 40.

In step S25, the signal receiving unit 50 transmits the control signal to the driving unit 60. The driving unit 60 adjusts the shooting angle of the camera lens 70 according to the control signal. In this embodiment, the shooting angle of the camera lens 70 is adjusted by moving the camera lens 70 to a position corresponding to the touch point.

In step S26, the images captured by the camera lens 70 are transmitted to the touch screen 12 via the network unit 40. The touch screen 12 displays the images.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A system for adjusting a shooting angle of a camera lens, the system comprising:
an electronic device comprising a touch screen to convert a contacting track of a touching device on the touch screen into a first electric signal, or convert a touch on the touch screen into a second electric signal;
a processing unit;
a storage system connected to the processing unit and storing at least two modules to be executed by the processing unit, wherein the at least two modules comprise:
a calculating module to obtain a displacement of the touching device on the touch screen in response to receipt of the first electric signal, or obtain a coordinate of the touch on the touch screen in response to receipt of the second electric signal; and
a control module to output a first control signal in response to receipt of the displacement of the touching device, or output a second control signal in response to receipt of the coordinate of the touch; and
a driving unit to receive the first or second control signal, and adjust the shooting angle of the camera according to the first or second control signal, wherein the touch screen is operable to display images captured by the camera lens.

2. The system of claim 1, further comprising a signal receiving unit, wherein the driving unit receives the first or second control signal via the signal receiving unit.

3. The system of claim 2, wherein the signal receiving unit is an interface of the driving unit.

4. The system of claim 2, wherein the signal receiving unit is an antenna.

5. The system of claim 2, further comprising a network unit connected between the signal receiving unit and the storage system.

6. The system of claim 1, wherein the driving unit is a pan motor.

7. A system for adjusting a shooting angle of a camera lens, the system comprising:
an electronic device comprising a touch screen to display images captured by the camera lens, and generate an electric signal relative to a contacting track of a touching device on the touch screen or a touch on the touch screen;
a processing unit;
a storage system connected to the processing unit and storing a plurality of modules to be executed by the processing unit, wherein the plurality of modules comprises:
a calculating module to receive the electric signal, and thereby obtain a displacement of the touching device on the touch screen or a coordinate of the touch on the touch screen; and
a control module to receive the displacement or the coordinate, and output a control signal; and
a driving unit to adjust the shooting angle of the camera according to the control signal.

8. The system of claim 7, further comprising a signal receiving unit transmitting the control signal to the signal receiving unit.

9. The system of claim 8, wherein the signal receiving unit is an interface of the driving unit.

10. The system of claim 8, wherein the signal receiving unit is an antenna.

11. The system of claim 8, further comprising a network unit, wherein the signal receiving unit receives the control signal via the network unit.

12. The system of claim 7, wherein the driving unit is a pan motor.

13. An adjustment method comprising:
generating an electric signal relative to a contacting track of a touching device on a touch screen or a touch on the touch screen;
processing the electric signal to obtain a displacement of the touching device on the touch screen or a coordinate of the touch on the touch screen;
outputting a control signal according to the displacement of the touching device on the touch screen or the coordinate of the touch on the touch screen; and
adjusting a shooting angle of a camera lens according to the control signal.

14. The method of claim 13, wherein the shooting angle of the camera lens is adjusted by moving the camera lens a required distance along a direction corresponding to the displacement of the touching device on the touch screen, or moving the camera lens to a position corresponding to the touch point.

15. The method of claim 13, further comprising displaying images captured by the camera lens on the touch screen.
